(19) United States
(12) Patent Application Publication
(10) Pub. No.: US 2016/0366464 A1
(43) Pub. Date: Dec. 15, 2016

(54) METHOD, DEVICE, AND SYSTEM FOR INTERACTIVE TELEVISION

(71) Applicant: Flune Interactive, Inc., Purcellville, VA (US)

(72) Inventors: William Rouady, Purcellville, VA (US); Tom Pixley, Springfield, VA (US); Hahn Cho, Los Angeles, CA (US)

(21) Appl. No.: 15/179,993

(22) Filed: Jun. 11, 2016

Related U.S. Application Data
(60) Provisional application No. 62/174,023, filed on Jun. 11, 2015.

(51) Int. Cl. H04N 21/431; H04N 21/482; H04N 21/8545; H04N 21/439

(52) U.S. Cl. CPC H04N 21/4312; H04N 21/439; H04N 21/482; H04N 21/8545

(57) ABSTRACT

The present disclosure relates to interactive television, and particularly to devices, systems, and methods for implementing interactive television. A studio control console and viewer device execute applications for respectively producing and viewing interactive broadcast video. Interactivity is provided using interactive overlays, which are sent from the studio control console to the viewer device separately from the streaming video, but displayed as an overlay upon the streaming video, which allows different overlays to be sent to different viewer devices for the same underlying streaming video. Information about the viewer's interaction with the interactive overlays can be provided to the studio control console, processed and additional overlays can be created based on the information.

### RELATED APPLICATIONS

The subject matter of this application is related to U.S. Provisional Application No. 62/174,023, filed on Jun. 11, 2015 and titled “METHOD, DEVICE, AND SYSTEM FOR INTERACTIVE TELEVISION”, which application is incorporated herein by reference in its entirety.

### BACKGROUND

The delivery of video has evolved over time from movie projectors, to broadcast television, and now to video streaming over the Internet. Each stage in this evolution has provided a more personalized experience. Broadcast television brought video into viewers homes and streaming video allows viewers to select what they watch, and when and where to watch it.

Compared to video streaming in which a viewer selects a video and has it unicasted directly to him/her, broadcasting video provides very little personalization or interactivity due to the nature of broadcasts, i.e., the video is delivered to a large number of receivers—and in the case of broadcast television it is delivered indiscriminately to any receiver that can “catch” the broadcast signal.

One common technique for providing more personalization to broadcast video is through the use of video overlays. A video overlay can obscure part of the underlying video to provide the viewer with supplementary information. A video overlay can also be implemented where the underlying video is shrunk and then encompassed by the video overlay. For example, during severe weather situations it is common for a local television station to shrink the video feed of an ongoing program to provide additional information about the severe weather. Similarly, a local television station may overlay a banner advertisement on a video feed received from a broadcast network.

Interactivity for broadcast television is typically implemented using a so-called “second screen.” In this case the interactivity is performed independent of the device displaying the video for which the interactivity is provided. For example, during a talent show broadcast over-the-air and on cable networks the viewers can be asked to vote for their favorite performer. This was originally implemented using telephone calls, and more recently using a second screen in the form of a computer, mobile phone, and tablet. A video overlay can then be included in the video broadcast announcing the results, such as in the form of an ongoing tally of votes. Due to the ubiquity of social media applications on most second screen devices, the voting is typically performed using functionality of the social media applications, such as “Likes” on Facebook or “Tweets” on Twitter.

### SUMMARY

The present disclosure relates to interactive television, and particularly to devices, systems, and methods for implementing interactive television. A studio control console and viewer device execute applications for respectively producing and viewing interactive broadcast video. Interactivity is provided using interactive overlays, which are sent from the studio control console to the viewer device separately from the streaming video, but displayed as an overlay upon the streaming video, which allows different overlays to be sent to different viewer devices for the same underlying streaming video. Information about the viewer's interaction with the interactive overlays can be provided to the studio control console, processed and additional overlays can be created based on the information.

In accordance with one aspect, a method involves: a studio control console receiving a video stream and overlay elements for display during designated portions of the video stream; associating the overlay elements with the designated portions of the video stream; transmitting the video stream to a first server, wherein the transmitted video stream does not include the overlay elements; and transmitting the overlay elements and association of the overlay elements with the designated portions of the video stream to a second server.

In accordance with one aspect, a studio control console includes: an interface configured to receive a video stream; an interface configured to receive overlay elements for display during designated portions of the video stream; a processor configured to associate associating the overlay elements with the designated portions of the video stream; and a transmitter configured to transmit the video stream to a first server, wherein the transmitted video stream does not include the overlay elements, and the transmitter is configured to transmit the overlay elements and association of the overlay elements with the designated portions of the video stream to a second server.

In accordance with one aspect, an interactive television platform includes: a studio control console application configured to associate overlay elements with designated portions of a video stream; and a viewer device application configured to receive overlay elements and the video stream and reproduce the overlay elements during display of the designated portions of the video stream. The interactive television platform can also include a database configured to store a timeline of when the overlay elements are to be displayed during the video stream and when a viewer device application interacted with one of the overlay elements.

In accordance with one aspect, a method for a viewer device involves: receiving a video stream and overlay elements for display during designated portions of the video stream; reproducing the video stream and the overlay elements during the designated portions of the video stream; and receiving and forwarding interactions with the overlay elements, wherein the video stream is received from a first server without the overlay elements, and wherein the overlay elements are received from a second server.

In accordance with one aspect, a viewer device includes: a receiver configured to receive a video stream and overlay elements for display during designated portions of the video stream; a processor configured to reproduce the video stream and the overlay elements during the designated portions of the video stream and configured to receive and forward interactions with the overlay elements, wherein the video stream is received from a first server without the overlay elements, and wherein the overlay elements are received from a second server.

In one aspect, a system, for producing and delivering video augmented with graphic overlays on a plurality of client-side viewer devices, includes: a studio control console comprising at least one processor executing a studio control console application providing a user interface configured for controlling the application to create overlay data, wherein the overlay data defines graphic overlay elements and specifies times at which the graphic overlay elements are to be displayed in association with a displayed video; a viewer device application executing on at least one processor of each of a plurality of viewer devices, the viewer device application configured to: receive and display a video stream, receive the overlay data separately from the video stream, display the graphic overlay elements specified by the overlay data at the specified times in association with the video stream, accept user input in response to displaying an interactive graphic overlay element, and transmit the accepted user input for receipt by the studio control console; and a host portable controller executing a host portable controller application in communication with the studio control console application, the host portable controller application configured to provide an additional user interface on a portable device, separate from the studio control console, for controlling the studio control console application, wherein the studio control console is further configured to create additional overlay data based on the transmitted accepted user input.

In one aspect the system can be implemented wherein the times at which the graphic overlays are to be displayed can be specified using at least: times relative to display of the video stream, absolute times independent of display of the video stream, instantaneous times for display upon receipt by the viewer device, and times relative to display of the video stream adjusted for a relative delay in displaying the video stream by a viewer device.

In one aspect the system can further include a video streaming server executing on a first server computer, the video streaming server configured to: receive the overlay data from the studio control console, transmit the overlay data to the plurality of viewer devices, and receive the transmitted accepted user input from the plurality of viewer devices.

In one aspect the system can be implemented wherein the video streaming serer is further configured to: aggregate transmitted accepted user input received from the plurality of viewer devices into aggregate viewer data, and transmit the aggregated viewer data to the studio control console.

In one aspect, a method includes: receiving, by a studio control console, a video stream; receiving, by the studio control console, overlay elements for display during designated portions of the video stream; associating, by the studio control console, the overlay elements with the designated portions of the video stream; transmitting, by the studio control console, the video stream to a first server, wherein the transmitted video stream does not include the overlay elements; and transmitting, by the studio control console, the overlay elements and association of the overlay elements with the designated portions of the video stream to a second server.

In one aspect, the method can be implemented wherein several alternative overlay elements are received for display during the designated portions of the video stream so that one of the several alternative overlay elements is selectively output during display of the designated portions of the video stream based on a receiver of the video stream.

In one aspect, the method can be implemented wherein the overlay elements are interactive overlay elements that are selectable by a receiver of the video stream.

In one aspect, the method can be implemented wherein some of the overlay elements are interactive overlay elements that are selectable by a receiver of the video stream and others of the overlay elements are static, non-interactive overlay elements.

In one aspect, a studio control console includes: at least one processor; and a memory storing instructions that, when executed by the at least one processor, cause the at least one processor to: receive a video stream, receive user input specifying overlay elements for display during designated portions of the video stream, associate the overlay elements with the designated portions of the video stream, transmit the video stream to a first server, wherein the transmitted video stream does not include the overlay elements, and transmit the overlay elements and association of the overlay elements with the designated portions of the video stream to a second server.

In one aspect, the studio control console can be implemented wherein the user input specifies one or more alternative overlay elements for display during the designated portions of the video stream so that one of the alternative overlay elements is selectively output during display of the designated portions of the video stream based on a receiver of the video stream.

In one aspect, the studio control console can be implemented wherein the overlay elements are interactive overlay elements that are selectable by a receiver of the video stream.

In one aspect, the studio control console can be implemented wherein some of the overlay elements are interactive overlay elements that are selectable by a receiver of the video stream and others of the overlay elements are static, non-interactive overlay elements.

### BRIEF DESCRIPTION OF THE DRAWINGS

FIG. 1 illustrates a block diagram of an exemplary system 100 in accordance with one embodiment.

FIG. 2 illustrates a display screen as displayed on a viewer device 120 in accordance with one embodiment.

FIG. 3 illustrates an example of static and interactive overlay elements on a display screen of a viewer device 120 in accordance with one embodiment.

FIG. 4 illustrates a block diagram of an example studio system 400 in accordance with one embodiment.

FIG. 5 is a flow diagram of an exemplary method performed by a studio control console in accordance with one embodiment.

FIG. 6 is an illustration of an exemplary display screen on a studio control console in accordance with one embodiment.

FIG. 7 is a flow diagram of an exemplary method performed by an interactive TV software platform in accordance with one embodiment.

FIG. 8 is a flow diagram of an exemplary method performed by a viewer device in accordance with the one embodiment.

FIG. 9 is an illustration of an exemplary display screen on a viewer device with a polling interactive element in accordance with one embodiment.

FIG. 10 is an illustration of an exemplary display screen on a viewer device with a quiz show interactive element in accordance with one embodiment.

FIG. 11 is an illustration of an exemplary display screen on a viewer device with a special interest interactive element in accordance with one embodiment.

FIG. 12 is an illustration of an exemplary display screen on a viewer device with interactive elements for an educational application in accordance with one embodiment.

FIGS. 13A-13D are illustrations of exemplary display screens on a viewer device with interactive elements for identifying products for consumers in accordance with one embodiment.

FIGS. 14A and 14B are illustrations of display screens on a viewer device with interactive elements for election returns in accordance with one embodiment.

FIG. 15 illustrates an example computer, one or more instances of which can be appropriately configured for use as any one or more of the studio control console, the viewer device, the server computers or the host portable controller.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

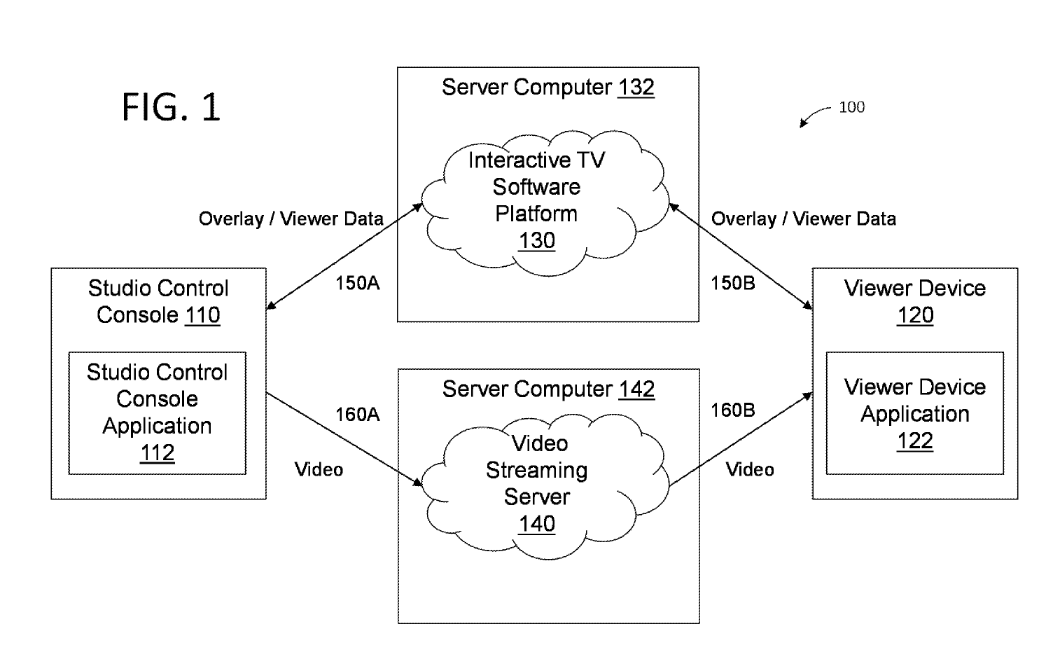

FIG. 1 illustrates a block diagram of an exemplary system 100 in accordance with one embodiment. The system includes a studio control console 110 coupled to a viewer device 120 via an interactive TV software platform 130 and a video streaming server numeral 140. The studio control console 110 can be a computer that executes a studio control console application 112, which supports interactive video composition and production. The interactive TV software platform 130 and the video streaming server 140 can be, for example, one or more servers or server applications executing on one or more network-connected server computers 132, 142, optionally in a cloud-based implementation.

Production of a video that includes interactive overlay elements can be achieved by using the studio control console application 112 running on the studio control console 110. A user can use the studio control console application 112 to produce the video and interactive overlays. The studio control console application 112 can be designed to provide a user-friendly interface so that the production of the video stream and associated interactive overlays does not require specialized skills.

The viewer device 120 can be any number of different devices, including a smart TV, a regular receive-only TV, a set-top box, a computer, a tablet, a smart phone, virtual reality system, and/or the like. The viewer device 120 be a computer or include a processor that executes a viewer device application 122, which displays the video and interactive overlay elements to a user.

The studio control console application 112 and/or the viewer device application 122 can each be a dedicated application or a web application that can be dynamically loaded and executed in a web browser. Web application implementations have a number of advantages, including ease of setup by the user, the ability to quickly change the user interfaces and functionality, avoiding the need to install updates of the application, and the ability of the applications to be end-device agnostic because all devices that can handle conventional technologies, such as HTML5, JavaScript, and CSS, can access the same application. The studio control console application 112 and the viewer device application 122 can be configured such that overlays created at the studio side are placed in the same location on the viewer screen using a pixel-for-pixel match.

The studio control console 110 can be configured to transmit overlay data created by the studio control console application optionally through the interactive TV software platform 130 to the viewer device 120. The overlay data can include information, such as overlay graphics and timings for display of the graphics, that is processed by the viewer device 120 in order to display graphical overlay elements over video displayed on the viewer device.

The viewer device 120 can be configured to transmit viewer data created by the viewer device application optionally through the interactive TV software platform 130 to the studio control console 110. The viewer data can include information, such as user input, such as clicks or user keystrokes, captured by the viewer device 120 in response to users' interactions with interactive overlays on the viewer device 120. The interactive software TV platform 130 and/or the studio control console 110 can be configured to process the viewer data and present the processed data to a user of the studio control console 110.

In one embodiment, overlay and viewer data can be exchanged separately from the video. As illustrated in FIG. 1, the overlay and viewer data can be sent over a communication link 150A via interactive TV software platform 130 and communication link 150B, and the video can be sent over communication link 160A via video streaming server 140 and communication link 160B. Communication links 150A and 150B on the upper side of FIG. 1 are illustrated with double-ended arrows to signify that the overlay elements and associated data are transmitted from the studio control console 110 to the viewer device 120 and viewer data is sent from the viewer device 120 to the studio control console 110. Although communication links 160A and 160B on the lower side of FIG. 1 are illustrated with single-ended arrows to signify the direction of the streaming video, it will be recognized that data may also be exchanged in the opposite direction, such as error control messaging for the streaming video and the like.

In one embodiment, the overlay and viewer data 150A and 150B can be exchanged over the same communication link as the video 160A and 160B. In one embodiment, the streaming video server 140 and the interactive TV software platform 130 can be integrated in unified application.

As video is streamed to different viewer devices over different networks various and different delays may be encountered at different devices when presenting the video to a user such that all presentations of a streamed video are not necessarily synchronized in real-time. The interactive TV software platform 130 can be configured to track delays and adjust its operation to account for such delays. For example, an interactive overlay can be configured to prompt viewers to select an answer to a question while providing an indication of an amount of time remaining to answer the question. The interactive TV software platform can adjust the indication of the displayed time allowed to answer a question to be shorter for a viewer device with greater delays to ensure that all viewer responses are collected and finalized at the same time.

The network(s) by which the viewer device 120 communicates with the interactive TV software platform 130 and video streaming server 140 can be any type of network, such as, for example, a cable network, over-the-air network, satellite network, digital subscriber line (DSL) network, fiber optic network, telephone network, and the like.

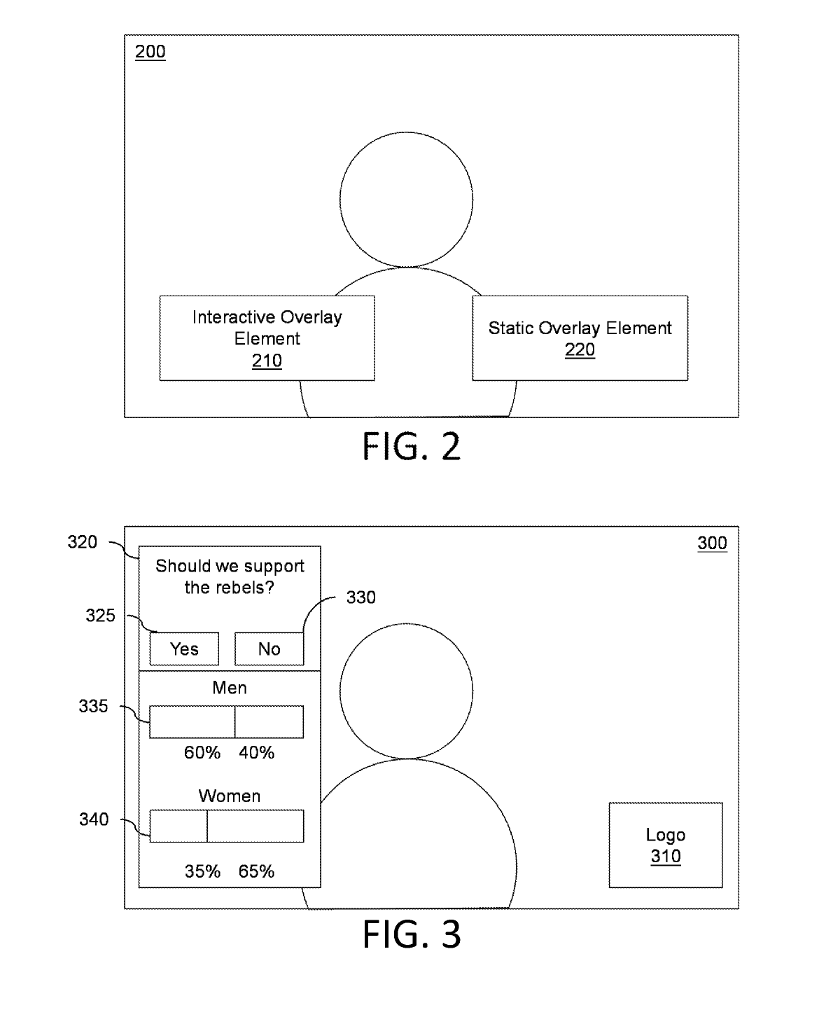

FIG. 2 illustrates a display screen as displayed on a viewer device 120 in accordance with one embodiment. As illustrated in FIG. 2, a video 200 can include an interactive overlay element 210 and a static overlay element 220. The video 200 can be sent via the video streaming server 140 while the interactive overlay element 210 can be sent via the interactive TV software platform 130. The static overlay element 220 can be sent via either the interactive TV software platform 130 or the video streaming server 140.

FIG. 3 illustrates an example of static and interactive overlay elements on a display screen of a viewer device 120 in accordance with one embodiment. The static overlay element can be, for example, a logo 310. The interactive overlay element can be, for example a polling question 320. Within the polling question interactive overlay element, the viewer device 120 can display interactive buttons 325 and 330, which can be selected by the viewer. The interactive overlay element 320 can also provide feedback as to the status of the poll, such as the breakdown of results by male viewers 335 and by female viewers 340.

The system 100 can provide the same overlay elements to each viewer device, and if desired can provide different overlay elements to different viewer devices based on any number of criteria, including viewer location, interests, gender, religion, etc. Referring to FIG. 3, the wording of the question “Should we support the rebels” can be different depending on a viewer's location so that viewers in certain locations may consider the force “rebels” while others view the force as “freedom fighters” and thus in this latter location the question would read “Should we support the freedom fighters.”

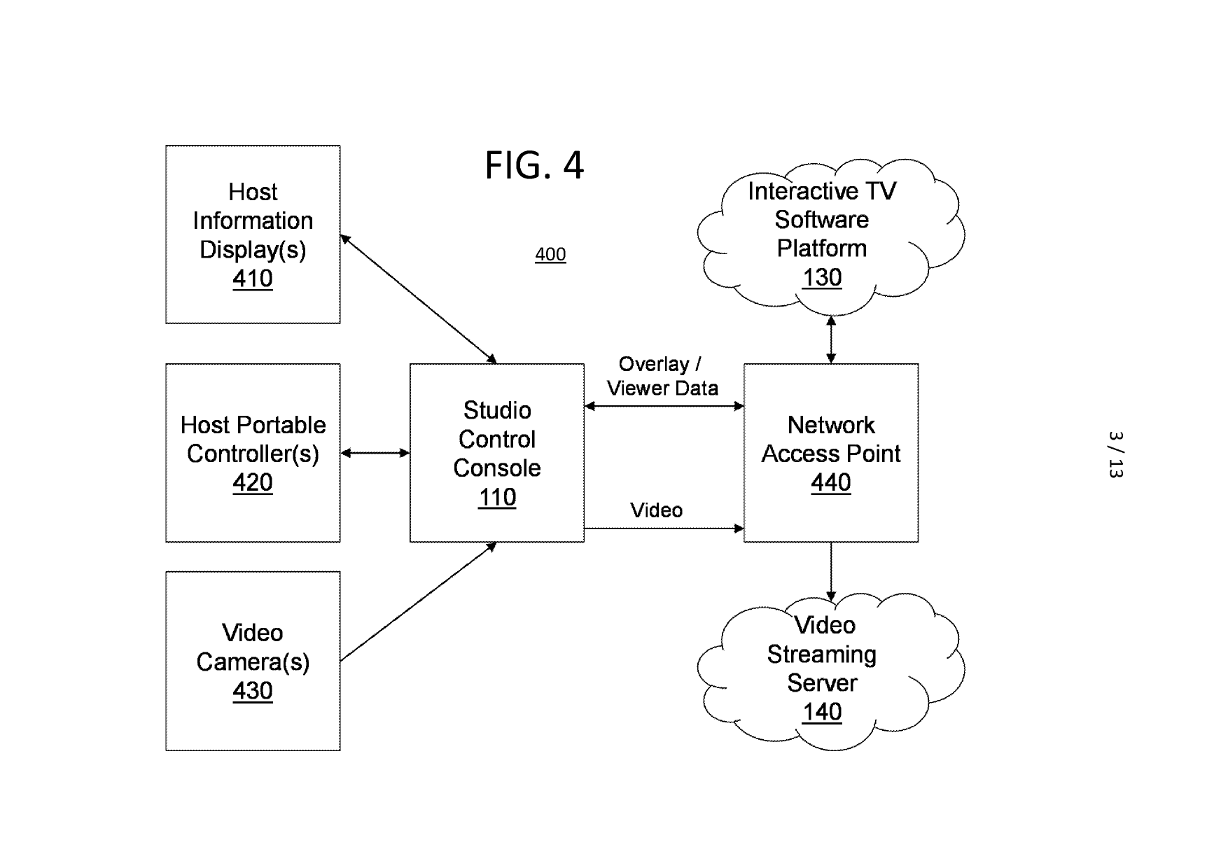

FIG. 4 illustrates a block diagram of an example studio system 400 configured to support a person hosting a video segment, in accordance with one embodiment. The person hosting the video segment, referred to herein as the host, can act, perform, or moderate within a video segment captured by a video camera 430 on a stage or set. Video camera 430 can be any type of device that captures video, including a camcorder, mobile phone, tablet, or computer. The video camera 430 can be configured to transmit captured video to the studio control console 110 for processing and the addition of overlays.

The host information display 410 can be display or screen that can be arrange or placed to display to the host (the person on the live set) what a viewer sees on the viewer device 120, some or all of the studio control console application user interface, or a combination thereof, and thus provides the host with feedback as to what the viewer is currently seeing. The host information display 410 can be either a “dumb device” such as a video monitor or television, or can include additional intelligence, such as a smart television or tablet.

The host portable controller 420 can be a portable device, such as a tablet, executing a host portable controller application (not illustrated) that the host can use to remotely control the studio control console 110, without being directly in front of studio control console 110. The host portable controller 420 can be, for example, a general-purpose tablet and/or a device specifically designed to control studio console 110. The host portable controller can be

Although FIG. 4 illustrates a single host information display 410, a single host portable controller 420, and a single video camera 430, it should be recognized that there could be more than one of any or all of these. The host information display 410, host portable controller 420, and video camera 430 can be coupled to studio control console 110 by wired or wireless connections.

In one embodiment, the studio control console 110 is connected to the interactive TV software platform 130 and the video streaming server 140 via a network access point 440. The network access point 440 can be any type of network access point, including a local area network access point (e.g., a router or modem) and a wide area network access point (e.g., a cellular base station for a cellular network). Thus, the system 400 can support the production of the interactive videos with overlay elements at any location with internet access, and is not limited to just a conventional video studio.

It should be recognized that the arrangement in FIG. 4 is merely exemplary and that not all of the devices need to be employed and that other devices can be employed. Further, although a studio control console 110 can be co-located with devices 410-430, the console and devices can each be located at different locations. Further, a remote studio console can be employed to control the studio control console 110 and/or devices 410-430.

In one embodiment or configuration, video can be configured to pass through the studio control console 110 on the way to the video streaming server 140. In the one embodiment or configuration, the video can be configured to bypass the studio control console 110. For example, for an on-location event where the viewers in the studio audience use second screen devices for interacting with the overlay elements, the video can be sent directly from one or more video cameras 430 either through the studio control console 110 or directly to the video streaming server 140. In the case of a previously recorded program, the program can be created or processed by the studio control console 110 and then stored in the video streaming server for later playback along with overlay elements from interactive TV software platform 130. These scenarios can also apply to video and overlay elements that are provided to a viewer that is not in a studio (e.g., at their home) in which case the video can be configured to optionally bypass the studio control console 110 and to be sent directly to the video streaming server.

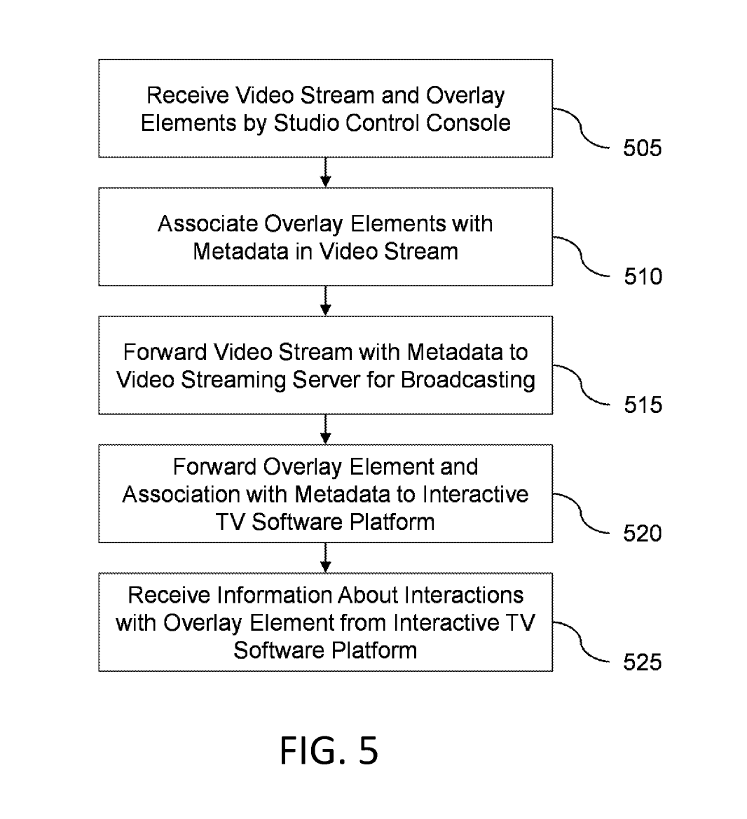

Now that an overview of the systems and devices that can be used in connection with the present invention has been provided, the operation will now be described in connection with FIGS. 5-14B.

FIG. 5 illustrates an exemplary method performed by studio control console 110 in accordance with one embodiment. As studio control console 110 receives a video stream from video camera 430 and overlay elements from host portable controller 420 and/or by an input device of the studio control console 110, such as a keyboard, mouse, touchscreen, track pad, etc., (step 505), the studio control console application associates the overlay elements with metadata in the video stream (step 510). The metadata can be conventional time coding or other time indicators used in video streams or it can be added to the video stream, such as an added time stamp, or a data element that instructs the receiver to show or hide the overlay element. This association thus controls when the overlay element(s) are displayed or hidden by the receiver. The location of where the overlay element is displayed can either be embedded in the overlay element itself or can be part of the metadata.

The association of overlay elements with metadata in the video stream (step 510) can be encoded as overlay data, for example, by identifying for each overlay element a time that is associated with a timestamps in the video stream at which the overlay element is to be displayed. The studio control console application causes the console 110 to forward the video to video stream server 140 via network access point 440 (step 515) and the overlay data to the interactive TV software platform 130 via network access point 440 (step 520). As viewers interact with the overlay elements and/or the streaming video, the console application receives information about such interactions from interactive software platform 130 (step 525). The information about the interactions can include a wide variety of information, such as whether the viewer interacts with an overlay element, how long an overlay element is displayed before the viewer interacts with it, how the viewer interacts with the overlay element (e.g., if the viewer selects one of a number of options, sends a question to the host, etc.), when in the video stream the viewer interacts with the overlay elements, as well as how the viewer interacts with the video stream (e.g., whether the viewer terminates the video stream, and at which point in the stream this occurs). Thus, the feedback information is integrated into the system, which provides the host operating the studio control console with real-time information about the effectiveness of the content of the video stream and/or the overlay element(s).

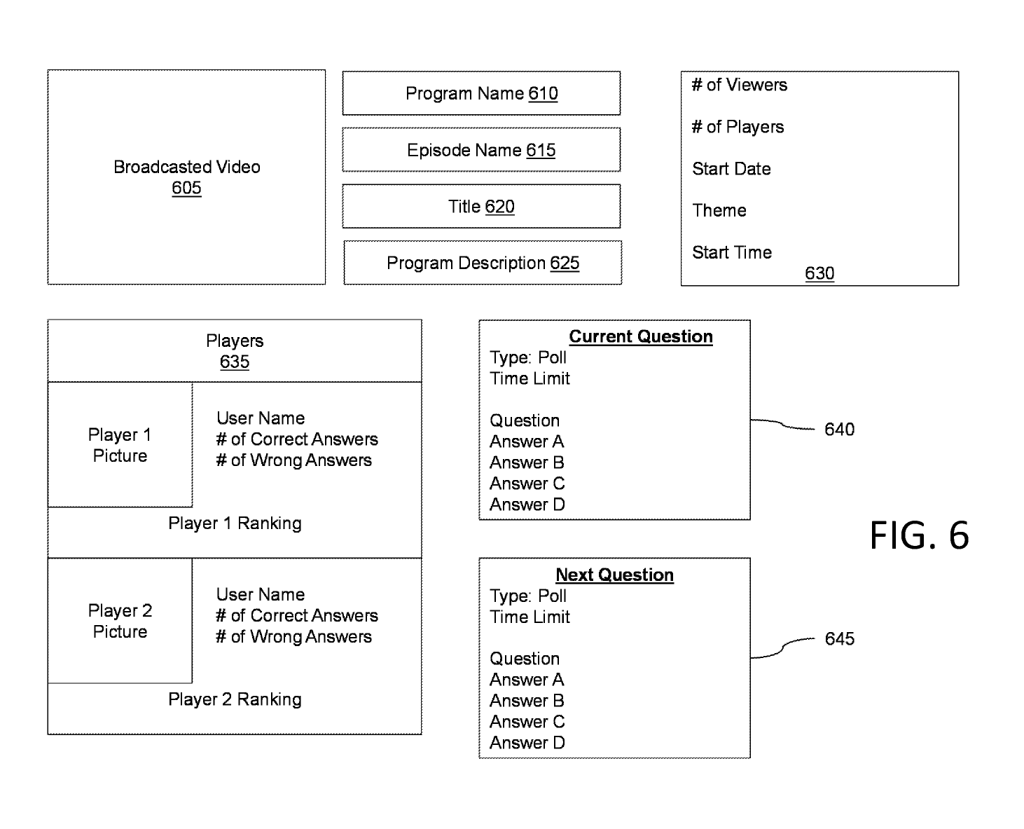

FIG. 6 illustrates an example user interface of the studio control console application 112 in accordance with one embodiment. The user interface can be output on the host information display 410 and/or the host portable controller 420. The illustrated example user interface is for overlay elements related to a poll, such as game show or an educational application. The user interface displays the broadcasted video 605 in the upper left-hand side of the screen. The video allows the host to confirm what the viewers are seeing so that, for example, if the host is showing an object, the host can confirm that the object is properly framed.

Next to the broadcasted video 605 is a variety of pieces of information related to the broadcasted video, including program name 610, episode name 615, title of the episode 620, and program description 625. Additional information 630 can include the number of current viewers, number of players, start date, theme, and start time. The number of current viewers may be different than the number of players for any variety of reasons, such as not all viewers interacting with the overlay elements or for some games there may be a limit to the number of players allowed.

The display can also include information about the players 635, such as a picture of each player, the players' user names, the number of correct and wrong answers by each player and each player's ranking. The display can further include information about the current question 640 and upcoming questions 645, including the type of question, the time limit for responding to questions, the question and the answer choices.

It will be recognized that the user interface of FIG. 6 is merely exemplary and that it can take any number of different forms, which can involve a different arrangement of the elements and/or more or fewer elements.

The studio control console 110 can include additional user interfaces, such as a video switcher and video effects interface, overlay and effects panels interface, audio mixer interface, stream output tool interface, interactive elements manager interface (including interactive elements input tools), a viewer input manager interface, and show controller interfaces. The studio control console application for the interactive TV software platform 130 can include application programming interfaces (APIs) to allow third-party plug-in modules and interfaces.

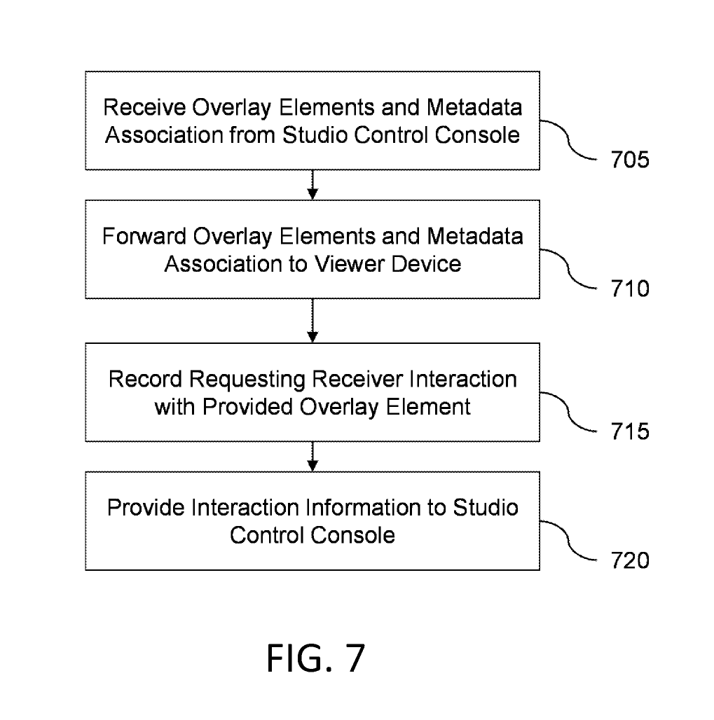

FIG. 7 is a flow diagram of a method performed by the interactive TV software platform 130 in accordance with one embodiment. The interactive TV software platform 130 receives overlay elements and metadata association from a studio control console 110 (step 705) and forwards this information to a viewer device 120 (step 710). The interactive TV software platform 130 receives viewer data from viewer device(s) 120, records the viewer's interaction with the video and the overlay elements (step 715) and forwards this information to the studio control console 110 (step 720).

In one embodiment, a timeline is used to associate the overlay elements with the broadcasted video, as well as to record when during the video a viewer interacts with an overlay element. Thus, the interactive TV software platform 130 can store a large amount of data indicating how and when the user(s) interact with the video and the overlay elements, which allows the host to refine the presentation. The user interaction information can be provided as a show is being broadcast, so the host can make the changes during the broadcast. Accordingly, even when a broadcast is initially receiving very poor viewer interaction, the host can make changes to increase the viewer interaction during subsequent portions of the broadcast. Further, by storing all of the information along with a timeline, a producer, such as a user who is operating the studio control console application 112, can mine the information after a program has been broadcast or can recreate a program in a recorded context.

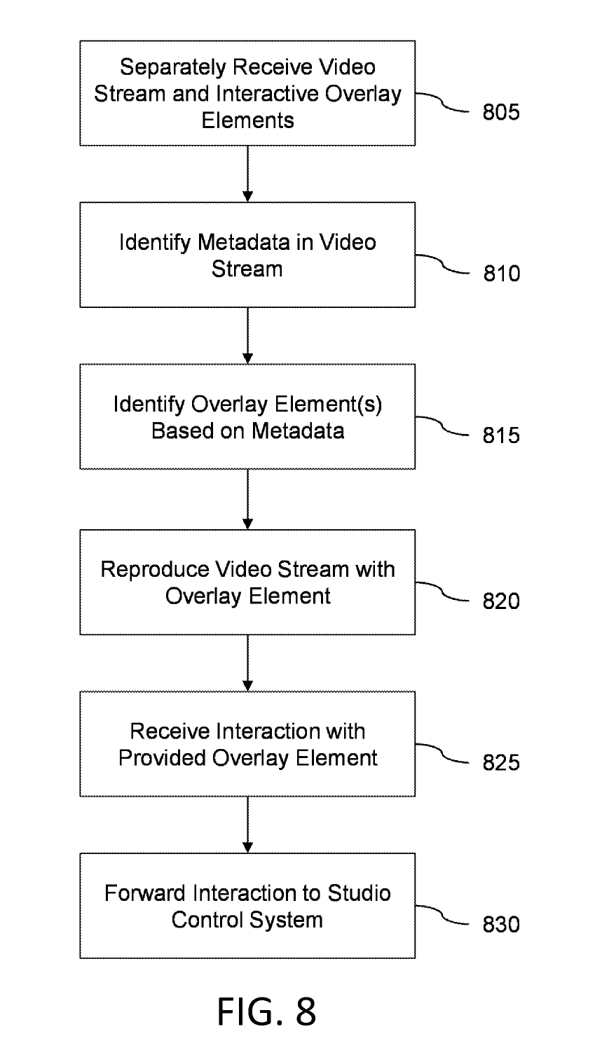

FIG. 8 is a flow diagram of a method performed by a viewer device 120 in accordance with one embodiment. Initially, the viewer device 120 separately receives the video stream from video streaming server 140 and the interactive overlay elements from interactive TV software platform 130 (step 805). The interactive overlay elements are received along with the metadata association so that the viewer device 120 can display the interactive overlay elements at the appropriate time during the video. The interactive overlay elements can be provided in advance of when the elements need to be displayed. This can occur in any number of ways, which can depend on how the host creates the interactive overlay elements. If the host creates one or more of the overlay elements in advance of the broadcast then these can be provided in bulk to the viewer device. If the host creates one or more overlay elements during the production of the video, the overlay elements can arrive at the viewer device in advance of when the elements need to be displayed because there will be less delay in transmitting the overlay elements from the studio control console 110 to the viewer device 120 compared to the streaming video. In one embodiment, overlay elements can be created on-the-fly and transmitted to viewer devices 120 to be displayed, changed or removed upon receipt, in real-time.

As the viewer device 120 receives the video stream, it identifies metadata in the stream (step 810), as well as the overlay elements(s) associated with the metadata (step 815). The viewer device 120 then reproduces the video stream with the overlay element (step 820), receives a viewer's interaction with the overlay element (step 825), and provides interaction information to the studio control system via the interactive TV software platform 130 (step 830).

As discussed above, in accordance with one embodiment, a second screen device, which may not receive the video stream itself, can be used to provide the overlay interactivity in one embodiment. This may be useful in a variety of contexts, such as when the viewer device 120 does not have the capability to receive, interpret and provide interactivity for the overlay elements (e.g., a regular television) or when there are multiple viewers using the same viewer device 120 for the video stream. This latter situation can involve a viewer device 120 that may or may not provide interactivity. When the viewer device 120 provides interactivity, then one viewer can use that device to interact with the overlay elements and the other viewers can use their second screen device. The second screen device can determine the timing of when to display overlay elements by listening to the audio output by the viewer device 120, similar to the technology underlying software such as Shazam and SoundHound. The second screen device can also use the timestamps or metadata embedded in the streaming video to determine the timing of when to display overlay elements. In this case, the second screen device receives the streaming video but does not necessarily output it to the viewer.

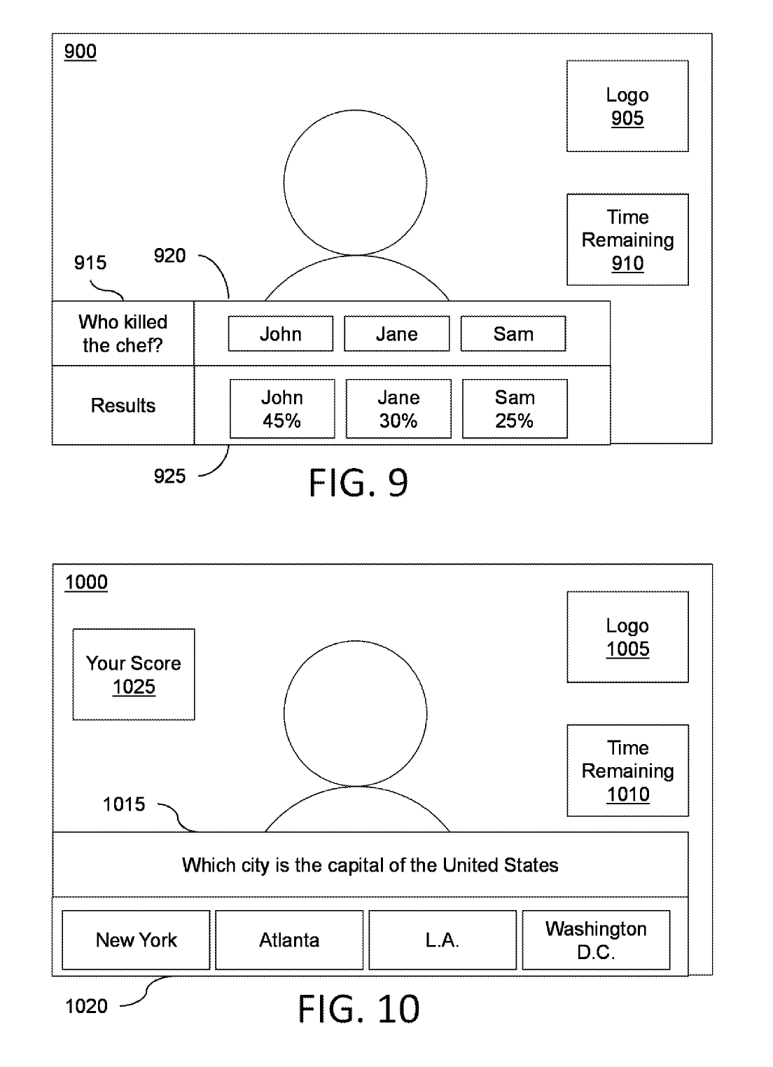

FIGS. 9-14B illustrate various examples of interactive overlay elements. The display of FIG. 9 can be used as part of a live or pre-recorded scripted television show to allow viewers to vote on aspects of the story line. This display 900 can include a number of overlay elements 905-925. Overlay element 905 can be a logo for the broadcast network and can be static or interactive. If the logo 905 is interactive it is sent via the interactive TV software platform 130 and if it is static it can be sent via either the interactive TV software platform 130 or can be embedded into the video stream passing through video streaming server 140. Interactive overlay element 910 can display the time remaining to select one of the choices for the poll 915. Interactive overlay element 920 provides buttons for the viewer to select their choice for responding to the poll and interactive overlay element 925 displays the results of the poll.

To avoid repetition in the discussion below, it is noted that the logos 1005, 1105, 1205, 1305, and 1405 can be static or interactive and can be sent in the same manner as logo 905.

The display in FIG. 10 can be used as part of an educational program or game show. In the case of a game show, this allows the viewer to compete against the contestants on the show's broadcasted video as well as other viewers. The interactive display elements in this example include the multiple choice answers 1020 and the viewer's score 1025. The time remaining for the question and/or the show 1010 and the question itself 1015 can be provided as static overlays in the same manner as the logos discussed above.

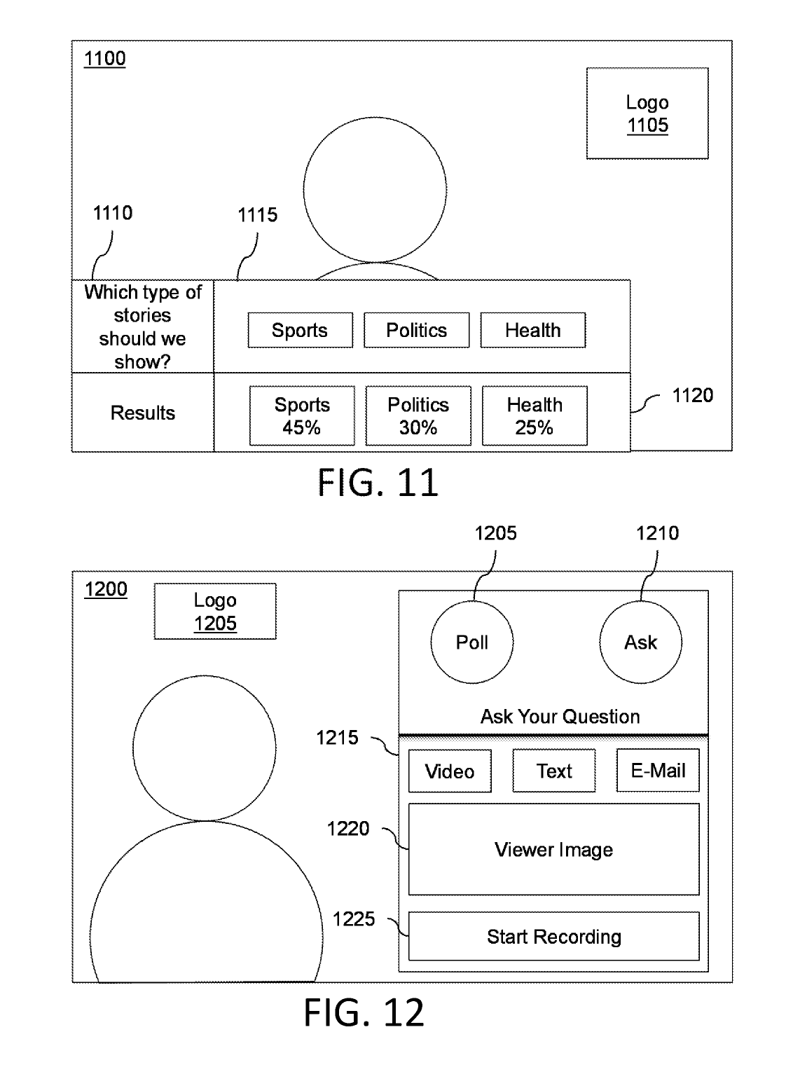

The display in FIG. 11 can be used as part of a news program in which the viewers can be asked 1110 which types of stories they would like to see more of 1115. The results 1120 can also be displayed. This can increase viewer retention and repeat viewers by allowing the broadcaster to fine tune the amount of time spent on particular stories to be more in line with their viewers' interests.

FIG. 12 is a display that can be used as part of an educational program. The interactive overlay elements can allow the viewer to respond to questions by selecting the “Poll” interactive element 1205 or ask a question of the host using the “Ask” interactive element 1210. In the example illustrated in FIG. 12, the “Ask” interactive element 1210 has been selected to provide the viewer with additional interactive elements 1215, 1220, and 1225 for use in asking a question. Specifically, the viewer can ask the question using video, a text message, or e-mail. In the illustrated example, the “Video” option can be selected, which produces the viewer's own image 1220, as well as an interactive overlay element 1225 for starting and stopping the recording of the viewer's image.

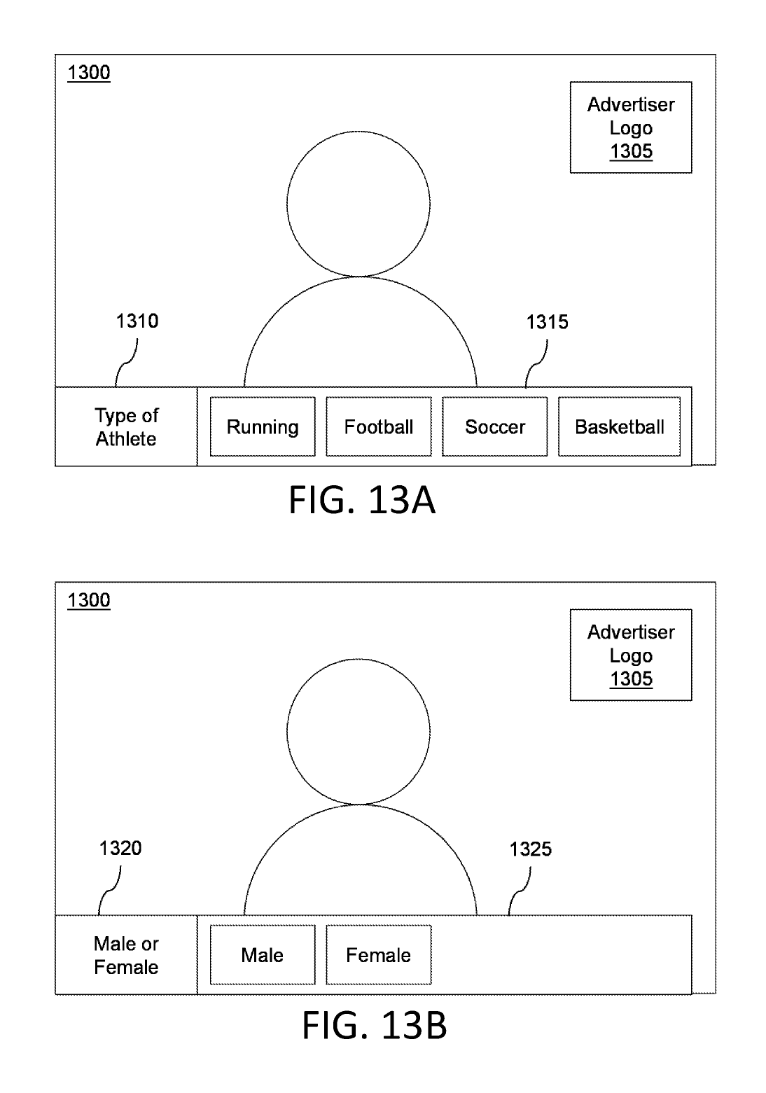

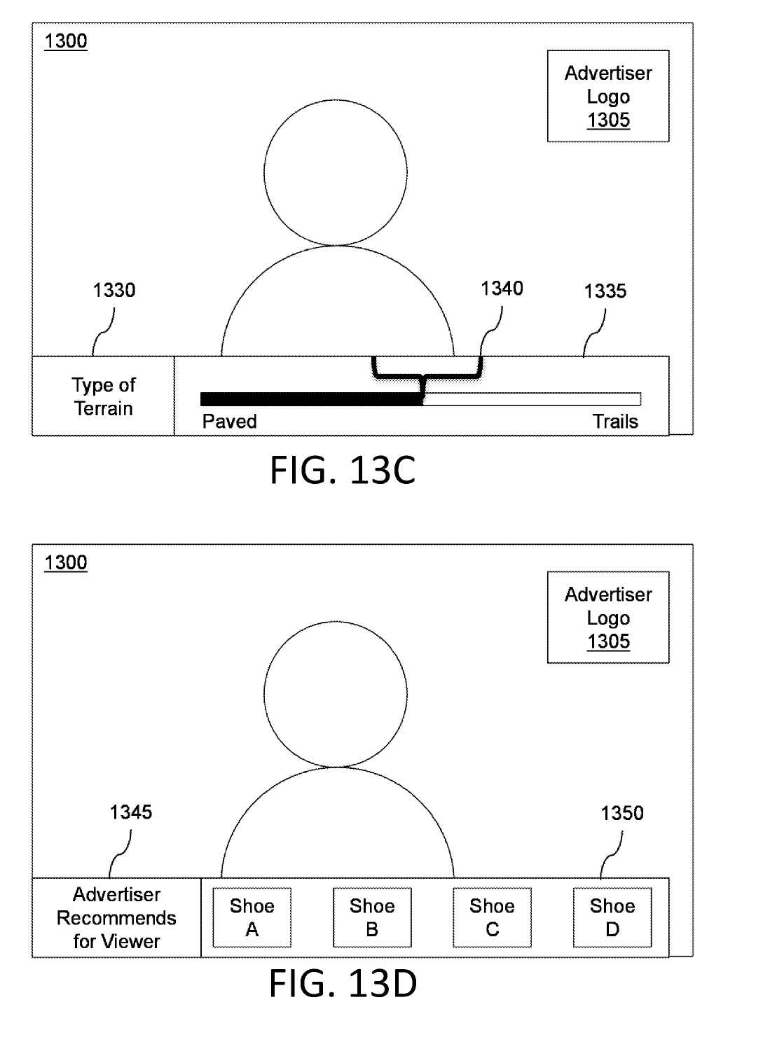

The displays illustrated in FIGS. 13A-13D can be used by an advertiser to better engage a viewer by allowing the viewer to provide information that is used to select from one of the advertiser's products. In this example, the advertiser can be an athletic footwear company. Accordingly, the viewer is asked about the type of athlete they are 1310, 1315 (FIG. 13A) and the viewer's gender 1320, 1325 (FIG. 13B). The viewer can then use a slide controller 1340 to identify the type of terrain they typically encounter 1330, 1335 (FIG. 13C). Based on the information provided by the viewer the advertiser can recommend one or more shoes 1345, 1350 (FIG. 13D).

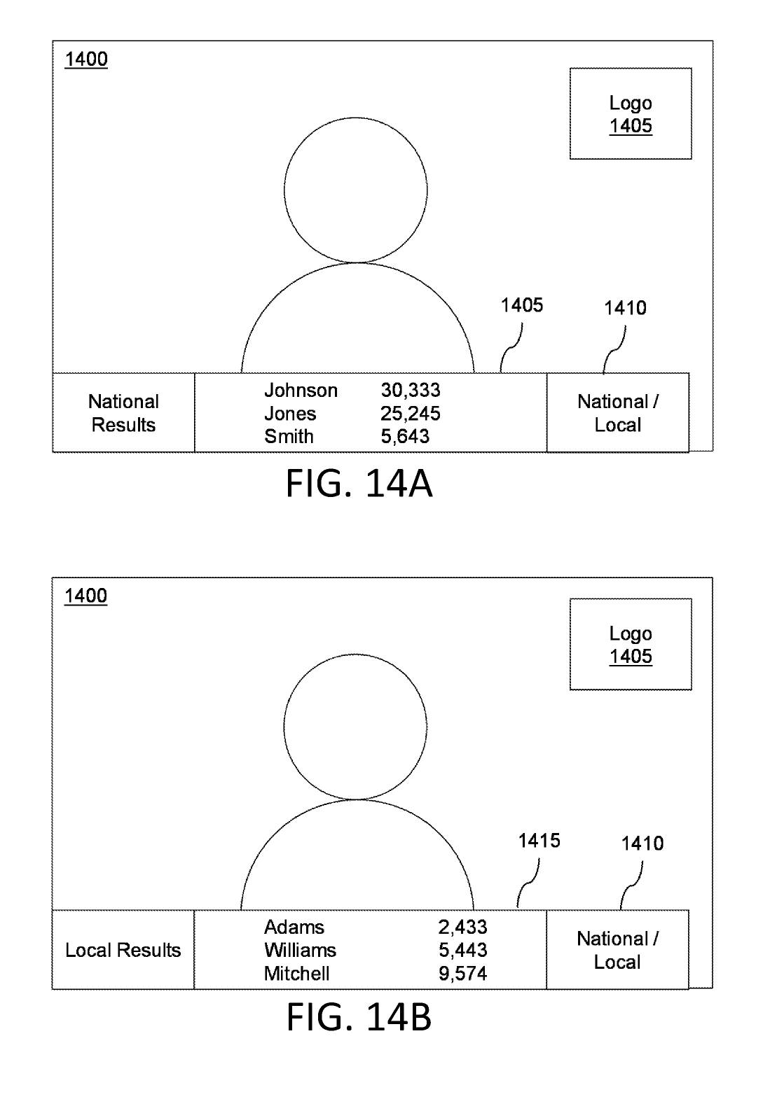

FIGS. 14A and 14B illustrate interactive overlay elements used for reporting election results. The viewer can select the “National/Local” election element 1410 to toggle between the display of national results 1405 (FIG. 14A) and local results 1415 (FIG. 14B). Additional interactive overlay elements can be provided to select different national and local results, if desired.

It should be recognized that the displays of FIGS. 9-14B are merely examples and more or less, as well as different types of, questions can be presented. Similarly, the types of interactive overlay elements are merely examples and other interactive overlay elements can be employed.

The functionality provided by the overlay elements described above represents only some of the functionality that can be employed with the present invention. The interactive overlay elements can provide direct links to purchase products displayed or discussed during the program, download a sample of a chapter of an author's new book, download a sample of a new song, request a recipe for a dish being demonstrated and receive the recipe via another medium, such as e-mail, along with a coupon.

In accordance with one embodiment, a host portable controller 420 or a co-located studio console 110 can be used, for example, by a teaching assistant to broadcast and monitor a live classroom lecture from a single device. Setting up a webcam trained on the teacher, the assistant/operator can send the stream and monitor for questions from the viewers that can then be related to the teacher either manually or through an automated display visible to the teacher. Polls or quiz questions can be initiated from the controller or console and the resulting aggregated answers can be displayed as a universal overlay on the feed being transmitted or can be triggered as personalized displays on the viewer's device directly through the interface. Multiple cameras can be used and the angles changed via the device. Remote viewers can use webcams to visually communicate their questions which also can be controlled through a queuing system in the device.

In accordance with one embodiment, timing of the viewer experience to a master clock represented by a feed timecode position at the studio control console 110 can be controlled individually for each viewer, which allows for the system to account for delays generated by the hardware platform, software platform, network connect, or drop-outs and freezes that put a local stream feed further behind prior to it naturally resyncing. The system can be configured to resync the video on viewer devices 120 using timing information. For example, when a stream is initially engaged, a “base delay” can be set. If due to drop-outs, delays or freezes over time the difference between the current delay and base delay reaches some defined critical amount, the time difference can be used to reset the stream to bring closer to the live timing. The reset can be handled directly with a simple cut, through a user option, or with a graphic transition to smooth the reset experience.

In accordance with one embodiment, the studio control console application associates static and/or interactive overlay elements with a video stream such that each overlay element has an associated time at which the overlay is to be displayed (or changed or removed) in association with the video stream. The time for each element to be displayed can be relative to times or timestamps in the associated video or the time can be relative to an absolute time or real-time clock to account for live streaming or polling situations. For an element to be displayed relative to times in the associated video, the viewer device 120 holds the element until the associated time in the displayed video at which point the element is displayed. When elements are displayed using relative times, different delays in displaying a live stream on different viewer devices 120 can be automatically accounted for such that the overlay elements are synchronized with the video stream as displayed on each device. This type of timing is particularly useful when the overlay elements are temporally related to the subject matter of the video.

For an element to be displayed relative to an absolute time, the viewer device 120 holds the element until the associated absolute time (e.g. as measured by a real-time clock) at which point the element is overlaid on the video. When elements are displayed using absolute times, different delays in displaying a live stream on different viewer devices 120 are generally not accounted for, such that the overlay elements are synchronized in real-time as displayed on each device. This type of timing is particularly useful when the overlay elements are used to convey live information in real-time, such as, for example, the closing of a viewer poll in real time. In addition to closing a poll in real-time, such as be changing or removing in interactive polling overlay, the results of the poll can also be displayed live in real time, independent of the timing or delays in the video. Accordingly, the time for an element to be displayed, changed or removed can also be specified to be immediate or upon receipt by the viewer device 120.

A relative time for an element to be displayed, changed or removed can also be configured to account for different delays experienced by different viewer devices 120 as they display the video. In one embodiment, the studio control console 110 and/or the interactive TV software platform 130 can be configured to monitor, request, or gather the delay experienced by each viewer device 120, so that relative display times can be adjusted to account for the longest delays being experienced. For example, the relative time to close a poll by removing a poll display element can be configured to be adjusted to account for a longest delay to some or all viewer devices, such that some or all viewers have at least a minimum amount of time to respond before the poll closes. A threshold of less than all viewers can be set to a percentage less than 100 to account for unusual viewer timing outliers.

For any stream, elements with relative time associations can be used in conjunction with elements with absolute time associations. Certain overlay elements can be synchronized relative to time within a stream's display, while other overlay elements can be synchronized in absolute time across all viewer devices. For example, the start of the display of an element displaying an interactive polling question can be associated with a relative time with respect to a video stream, while the end of the displaying of the element, closing the poll, can be associated with an absolute time. To account for different delays in stream display on different viewer devices 120, the amount of time between the beginning and end a poll is effectively adjusted so that the end of the poll is synchronized in real time for all users. In this manner, different viewer devices 120 may hold the poll open for different amounts of time, depending, for example, on communication delays, so that the poll can end at the same absolute time for all viewers. Therefore, users with a longer delay in their streams may be given less time to respond to a poll.

Exemplary embodiments of the invention have been described above as involving a number of devices as part of an overall system. These devices can be used separately from the system in various implementations.

Although the interactive overlay elements of the present invention avoid the need to outsource interactivity to third-party providers, such as Twitter and Facebook, the present invention can also incorporate such interactivity to allow the viewer to select the interactivity mechanism that is most comfortable for them.

Although exemplary embodiments of the invention have been described in connection with live video streaming, the present invention can also be employed with streaming of pre-recorded video. The pre-recorded video can be broadcast like the live streaming video or it can be unicast, on-demand by individual viewers.

The combination of pre-recorded video with the interactive overlay elements of the present invention provides for a more personalized video stream. For example, all viewers of a broadcasted pre-recorded video can view the same initial portion of the video stream and then different subsets could see different subsequent video streams based on viewers' interactions with the interactive overlay elements.

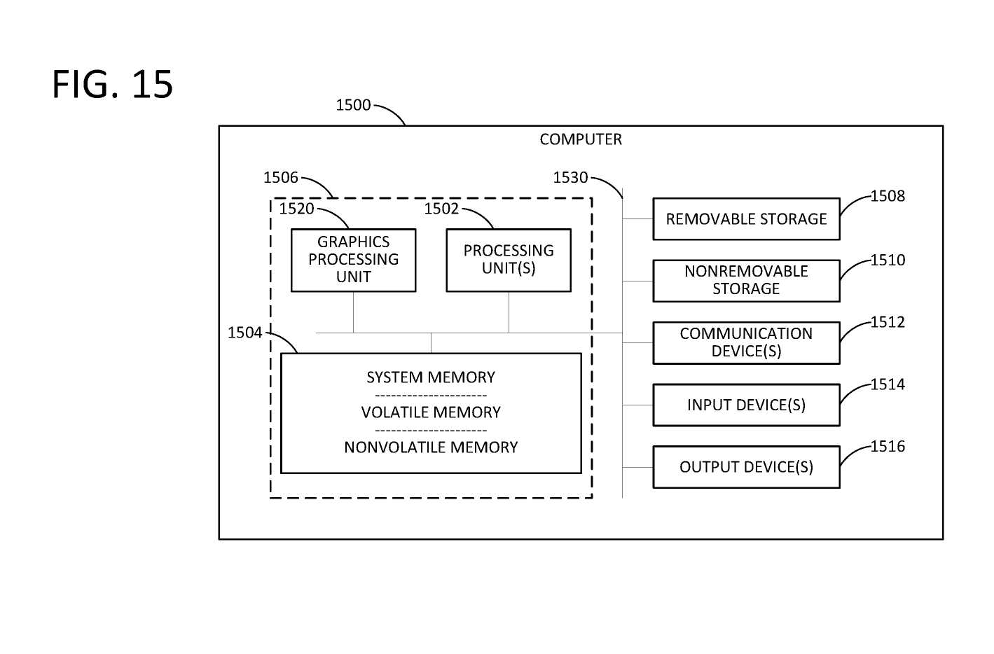

FIG. 15 illustrates an example computer 1500, one or more instances of which can be appropriately configured for use as any one or more of, for example, the studio control console 110, the viewer device 120, the server computers 132, 142 or the host portable controller 420. Components of the embodiments disclosed herein, which may be referred to as modules, engines, processes, functions or the like, can be implemented by configuring one or more instances of the example computer using special purpose software or applications, possibly in different configurations and optionally networked, as a computer system. The computer 1500 can be any of a variety of general purpose computers such as, for example, a server, a desktop computer, a laptop computer or a mobile computing device.

On a general purpose computer, a processor typically executes computer programs which include an operating system and applications. The operating system is a computer program running on the computer that manages access to various resources of the computer by the applications and the operating system. The various resources generally include memory, storage, communication interfaces, input devices and output devices.

With reference to FIG. 15, the example computer 1500 includes at least one processing unit 1502 and memory 1504. The computer can have multiple processing units 1502 and multiple devices implementing the memory 1504. A processing unit 1502 can include one or more processors or processing cores (not shown) that operate independently of each other. Additional co-processing units, such as graphics processing unit 1520, also can be present in the computer. The memory 1504 may include volatile devices (such as dynamic random access memory (DRAM) or other random access memory device), and non-volatile devices (such as a read-only memory, flash memory, and the like) or some combination of the two. This configuration of memory is illustrated in FIG. 15 by dashed line 1506. The computer 1500 may include additional storage (removable and/or non-removable) including, but not limited to, magnetically-recorded or optically-recorded disks or tape. Such additional storage is illustrated in FIG. 15 by removable storage 1508 and non-removable storage 1510. The various components in FIG. 15 are generally interconnected by an interconnection mechanism, such as one or more buses 1530.

A computer storage medium is any medium in which data can be stored in and retrieved from addressable physical storage locations by the computer. Computer storage media includes volatile and nonvolatile memory devices, and removable and non-removable storage media. Memory 1504 and 1506, removable storage 1508 and non-removable storage 1510 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 1500 may also include communication device(s) 1512 through which the computer communicates with other devices over a communication medium such as a computer network. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals.

Communications device(s) 1512 can include, for example, a network interface or radio transmitter, that interface with the communication media to transmit data over and receive data from signals propagated through communication media. The communication device(s) 1512 can include one or more radio transmitters for telephonic communications over cellular telephone networks, and/or wireless connections to a computer network. For example, a cellular connection, a Wi-Fi connection, a Bluetooth connection, and other connections may be present in the computer. Such connections support communication with other devices, such as to support voice or data communications.

The computer 1500 may have various input device(s) 1514 such as a keyboard, mouse, touchscreen and pen, image input devices, such as still and motion cameras, audio input devices, such as a microphone, and various sensors, such as accelerometers, thermometers and magnetometers. Output device(s) 1516 such as a display, speakers, printers, and so on, also may be included.

The various storage 1510, communication device(s) 1512, output devices 1516 and input devices 1514 can be integrated within a housing of the computer, or can be connected through various input/output interface devices on the computer, in which case the reference numbers 1510, 1512, 1514 and 1516 can indicate either the interface for connection to a device or the device itself as the case may be.

An operating system of the computer typically includes computer programs, commonly called drivers, that manage access to the various storage 1510, communication device(s) 1512, output devices 1516 and input devices 1514. Such access generally includes managing inputs from and outputs to these devices. In the case of communication device(s), the operating system also may include one or more computer programs for implementing communication protocols used to communicate information between computers and devices through the communication device(s) 1512.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A computer system may be practiced in distributed computing environments where operations are performed by multiple computers that are linked through a communications network. In a distributed computing environment, computer programs may be located in both local and remote computer storage media.

Each component of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Components of the embodiments disclosed herein, which may be referred to as modules, engines, processes, functions or the like, can be implemented in hardware, such as by using special purpose hardware logic components, by configuring general purpose computing resources using special purpose software, or by a combination of special purpose hardware and configured general purpose computing resources. Illustrative types of hardware logic components that can be used include, for example, Field-programmable Gate Arrays (FPGAs), Program-specific Integrated Circuits (ASICs), Program-specific Standard Products (ASSPs), System-on-a-chip systems (SOCs), and Complex Programmable Logic Devices (CPLDs).

It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A system for producing and delivering video augmented with graphic overlays on a plurality of client-side viewer devices, the system comprising:
a studio control console comprising at least one processor executing a studio control console application providing a user interface configured for controlling the application to create overlay data, wherein the overlay data defines graphic overlay elements and specifies times at which the graphic overlay elements are to be displayed in association with a displayed video;
a viewer device application executing on at least one processor of each of a plurality of viewer devices, the viewer device application configured to:
receive and display a video stream,
receive the overlay data separately from the video stream,
display the graphic overlay elements specified by the overlay data at the specified times in association with the video stream,
accept user input in response to displaying an interactive graphic overlay element, and
transmit the accepted user input for receipt by the studio control console; and
a host portable controller executing a host portable controller application in communication with the studio control console application, the host portable controller application configured to provide an additional user interface on a portable device, separate from the studio control console, for controlling the studio control console application,
wherein the studio control console is further configured to create additional overlay data based on the transmitted accepted user input.

2. The system of claim 1, wherein the times at which the graphic overlays are to be displayed can be specified using at least:
times relative to display of the video stream,
absolute times independent of display of the video stream,
instantaneous times for display upon receipt by the viewer device, and
times relative to display of the video stream adjusted for a relative delay in displaying the video stream by a viewer device.

3. The system of claim 1, further comprising a video streaming server executing on a first server computer, the video streaming server configured to:
receive the overlay data from the studio control console,
transmit the overlay data to the plurality of viewer devices, and
receive the transmitted accepted user input from the plurality of viewer devices.

4. The system of claim 3, wherein the video streaming serer is further configured to:
aggregate transmitted accepted user input received from the plurality of viewer devices into aggregate viewer data, and
transmit the aggregated viewer data to the studio control console.

5. A method, comprising:
receiving, by a studio control console, a video stream;
receiving, by the studio control console, overlay elements for display during designated portions of the video stream;
associating, by the studio control console, the overlay elements with the designated portions of the video stream;
transmitting, by the studio control console, the video stream to a first server, wherein the transmitted video stream does not include the overlay elements; and
transmitting, by the studio control console, the overlay elements and association of the overlay elements with the designated portions of the video stream to a second server.

6. The method of claim 5, wherein several alternative overlay elements are received for display during the designated portions of the video stream so that one of the several alternative overlay elements is selectively output during display of the designated portions of the video stream based on a receiver of the video stream.

7. The method of claim 5, wherein the overlay elements are interactive overlay elements that are selectable by a receiver of the video stream.

8. The method of claim 5, wherein some of the overlay elements are interactive overlay elements that are selectable by a receiver of the video stream and others of the overlay elements are static, non-interactive overlay elements.

9. A studio control console, comprising:
at least one processor; and
a memory storing instructions that, when executed by the at least one processor, cause the at least one processor to:
receive a video stream,
receive user input specifying overlay elements for display during designated portions of the video stream,
associate the overlay elements with the designated portions of the video stream,
transmit the video stream to a first server, wherein the transmitted video stream does not include the overlay elements, and
transmit the overlay elements and association of the overlay elements with the designated portions of the video stream to a second server.

10. The studio control console of claim 9, wherein the user input specifies one or more alternative overlay elements for display during the designated portions of the video stream so that one of the alternative overlay elements is selectively output during display of the designated portions of the video stream based on a receiver of the video stream.

11. The studio control console of claim 9, wherein the overlay elements are interactive overlay elements that are selectable by a receiver of the video stream.

12. The studio control console of claim 9, wherein some of the overlay elements are interactive overlay elements that are selectable by a receiver of the video stream and others of the overlay elements are static, non-interactive overlay elements.
